(19) United States
(12) Patent Application Publication
(10) Pub. No.: US 2007/0180115 A1
(43) Pub. Date: Aug. 2, 2007

(54) System and method for self-configuring multi-type and multi-location result aggregation for large cross-platform information sets

(75) Inventors: Peter C. Bahrs, Austin, TX (US); Roland Barcia, Leonia, NJ (US); Gang Chen, Oceanside, NY (US); Bonita Oliver Vincent, Pflugerville, TX (US); Liang Zhang, San Jose, CA (US)

Correspondence Address: IBM CORPORATION- AUSTIN (JVL);C/O VAN LEEUWEN & VAN LEEUWEN, PO BOX 90609, AUSTIN, TX, 78709-0609, US

(73) Assignee: International Business Machines Corporation

(21) Appl. No.: 11/345,921

(22) Filed: Feb. 2, 2006

(51) Int. Cl. G06F 15/173

(52) U.S. Cl. 709/226

(57) ABSTRACT

A system and method for self-configuring multi-type and multi-location result aggregation for large cross-platforms is presented. An enterprise tier component includes a request manager that receives query requests from a distribution tier component over a request path. The request manager retrieves one or more data thresholds and compares the data query's result to the data thresholds. When the data query result is less than the data thresholds, the request manager sends the data query result to the distribution manager over the request path. However, when the data query result exceed one of the data thresholds, the request manager stores the data query result in a temporary storage area and sends metadata, which includes the temporary storage area location, to the distribution tier component over the request path. In turn, the distribution tier component retrieves the data query result directly from the temporary storage area over a dedicated data path.

### BACKGROUND OF THE INVENTION

1. Technical Field

The present invention relates to a system and method for self-configuring multi-type and multi-location result aggregation for large cross-platform information sets.

More particularly, the present invention relates to a system and method for providing a large data query result to a software component over a data path in order to alleviate request path congestion.

2. Description of the Related Art

Typical distributed J2EE applications utilize several patterns and technologies across multiple servers. These distributed applications include software components that communicate with each other through a “request path.” The request path typically uses a business logic language, such as extensible mark-up language (XML), to send query requests and query results between the software components.

In many cases, data query result may be large, or may take an extended amount of time to process. A challenge found with sending these data query result over the request path is that the request path adds the additional business logic language to the data. For example, a satellite bank may request 50 MB of data from a central banking location. In this example, the 50 MB of data is converted to XML and sent over the request path. As a result, a distributed application's data request and retrieval process often times leads to poor application response time, system timeouts, network bandwidth spikes, system resource usage spikes, and servers crashing due to storage space limitations.

Furthermore, in current J2EE (Java 2 Enterprise Edition) architectures, many points exist within the application flow that serializes data. A challenge found is that many protocol layers are built around the data, which results in a cumbersome process to provide or retrieve the data. This problem amplifies when dealing with large amounts of data or when the data is aggregated from multiple sources.

What is needed, therefore, is a system and method for providing large data query result to distributed software components without congesting the software component's request path.

### SUMMARY

It has been discovered that the aforementioned challenges are resolved using a system and method for providing a large data query result to a software component over a data path in order to alleviate request path congestion. An enterprise tier component includes a request manager that receives query requests from a distribution tier component over a request path. The request manager retrieves one or more data thresholds (e.g., size or time limits) and compares the data query's result to the data thresholds. When the data query result is less than the data thresholds, the request manager sends the data query result to the distribution manager over the request path. However, when the data query result exceeds one of the data thresholds, the request manager stores the data query result in a temporary storage area and sends metadata, which includes the location of the temporary storage area, to the distribution tier component over the request path. In turn, the distribution tier component retrieves the data query result directly from the temporary storage area over a “data path.” As a result, the request path is not congested when the distribution tier component retrieves the data query result.

A distribution tier component and an enterprise tier component, which are server-side software components, work in conjunction with each other to provide information to a particular application. For example, the distribution tier component may be located at a branch bank, which requests account information from the enterprise tier component that resides at a central banking location. When the distribution tier component requires data, the distribution tier component sends a query request to the enterprise tier component over a request path. The request path may use a generic application language to send and receive information, such as extensible markup language (XML). In addition, the query request may request multiple types of data, such as customer mailing information and customer banking activity, each of which may be located in different databases at a central banking location.

The enterprise tier component includes a request manager, which retrieves data thresholds from a threshold storage area, and determines whether the data query's result exceeds one of the data thresholds, such as a size limit, a retrieval time limit, or a security check threshold. When the data query result does not exceed a data threshold, the request manager retrieves the data query result from a data storage area and includes the data query result into a response, which is sent to the distribution tier component over the request path. The distribution tier component receives the response and processes the data query result accordingly.

However, when the data query result exceeds one of the data thresholds, the request manager invokes an independent thread to transfer the data query result from the data storage area to a temporary storage area. In one embodiment, the temporary storage area may be local to the distribution tier component in order to provide the distribution tier component with a more convenient retrieval process.

The request manager generates metadata and includes the metadata into a response, which is sent to the distribution tier component over the request path. The metadata includes a temporary storage location identifier that identifies the location of the data query result, and may also include a “retrieval timeframe” that the distribution tier component may use to retrieve the data. For example, the data query result may be 50 MB of data. In this example, instead of converting the 50 MB of data to XML and sending it over the request path, the enterprise tier component stores the raw data in the temporary storage area and instructs the distribution tier to retrieve the raw data directly from the temporary storage area.

During the specified retrieval timeframe, the distribution tier component retrieves the data query result from the temporary store area using a “data path,” which does not congest the request path. The data path is configured for data access and retrieval and, therefore, does not use overhead application language such as that used in the request path.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 is an exemplary diagram showing an embodiment of an enterprise tier component receiving a data query request from a distribution tier component, and deciding to provide data query result to the distribution tier component over a request path;

FIG. 2 is an exemplary diagram showing an embodiment of a request manager receiving a data query request from a distribution tier component and, in turn, providing metadata to the distribution tier component that corresponds to the location of the data query result;

FIG. 3 is a flowchart showing steps taken in an enterprise tier component providing data to a distribution tier component through direct means or through a temporary storage area;

FIG. 4 is an example of metadata that a server provides to a distribution tier component when the distribution tier component's data request exceeds one or more data thresholds;

FIG. 5 is an interaction diagram corresponding to an embodiment of the present invention showing a stored procedure deciding that a data query result does not exceed one or more data thresholds;

FIG. 6 is an interaction diagram corresponding to an embodiment of the present invention showing a stored procedure deciding that a data query result exceeds one or more data thresholds;

FIG. 7 is an interaction diagram corresponding to an embodiment of the present invention showing a middleware application deciding that a data query result does not exceed one or more data thresholds;

FIG. 8 is an interaction diagram corresponding to an embodiment of the present invention showing a middleware application deciding that a data query result exceeds one or more data thresholds; and

FIG. 9 is a block diagram of a computing device capable of implementing the present invention.

### DETAILED DESCRIPTION

The following is intended to provide a detailed description of an example of the invention and should not be taken to be limiting of the invention itself. Rather, any number of variations may fall within the scope of the invention, which is defined in the claims following the description.

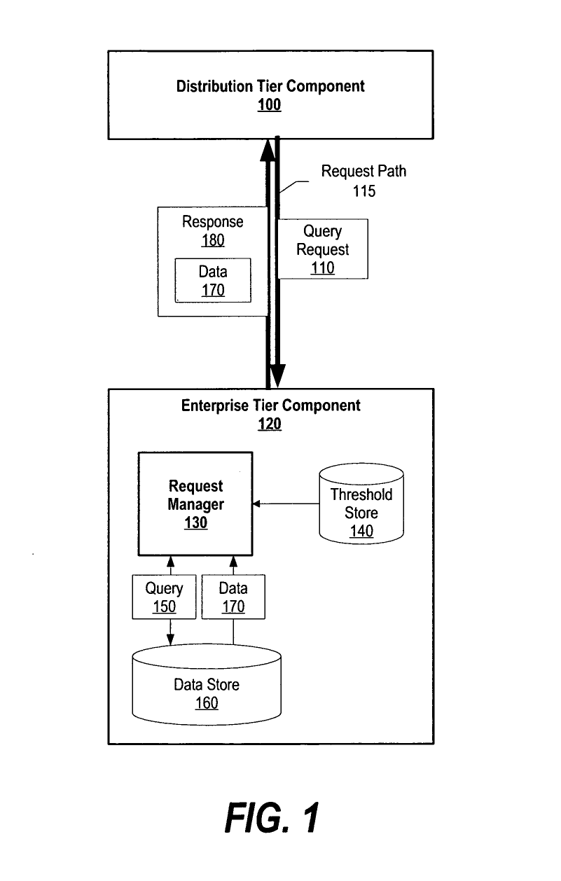

FIG. 1 is an exemplary diagram showing an embodiment of an enterprise tier component receiving a data query request from a distribution tier component, and deciding to provide data query result to the distribution tier component over a request path. Distribution tier component 100 and enterprise tier component 120 are server-side software components that work in conjunction with each other to provide information to a particular application. For example, distribution tier component 100 may be located at a branch bank, which requests account information from enterprise tier component 120 that resides at a central banking location.

When distribution tier component 100 requires data, distribution tier component 100 sends query request 110 to enterprise tier component 120 over request path 115. Request path 115 may use a generic application language to send and receive information, such as Structured Query Language (SQL) or Java Messaging Service (JMS). Query request 110 may request one or more types of data. Using the example described above, query request 110 may request customer mailing information as well as customer banking activity, each of which may be located in different databases at the central banking location.

Enterprise tier component 120 includes request manager 130, which retrieves data thresholds from threshold store 140 and determines whether results of the data query will exceed one of the data thresholds, such as a size limit or a retrieval time limit. FIG. 1 shows that request manager 130 queries data store 160 (query 150) and determines that the data query result do not exceed one of the data threshold. As such, request manager 130 retrieves the data query result (data 170) from data store 160 and includes data 170 into response 180, which is sent to distribution tier component 100 over request path 115.

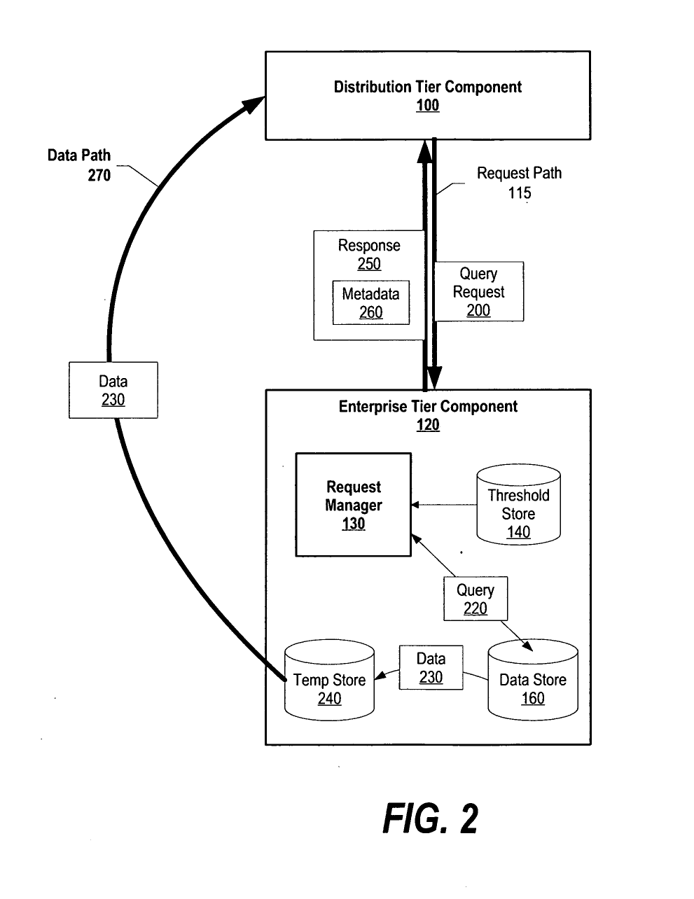

When request manager 130 determines that the data required to fulfill query request 110 does exceed a data threshold, request manager 130 stores the data in a temporary storage area, and instructs distribution tier component 100 to retrieve the data directly from the temporary storage area in order to not congest request path 115 (see FIG. 2 and corresponding text for further details).

FIG. 2 is an exemplary diagram showing an embodiment of a request manager receiving a data query request from a distribution tier component and, in turn, providing metadata to the distribution tier component that corresponds to the location of the data query result. Distribution tier component 100 sends query request 200 to enterprise tier component 120 over request path 115. The difference between query request 110 and query request 200 is that query request 200's data query result is large. For example, query request 200's result may be 50 MB of data. In this example, instead of converting the 50 MB of data to XML and sending it over request path 115, enterprise tier component 120 may store the raw data in a temporary storage area and have distribution tier 100 retrieve the raw data directly from the temporary storage area.

Request manager 130 retrieves data thresholds from thresholds store 140, and receives query request 200. In turn, request manager 130 queries data store 160 (query 220) and determines that the data required to fulfill request 220 exceeds one of the data thresholds. As such, request manager 130 invokes an independent thread to transfer data 230 from data store 160 to temporary store 240. Temporary store 240 may be stored on a nonvolatile storage area, such as a computer hard drive. Temporary store 240 may also be local to distribution tier component 100 in order to provide distribution tier component 100 with a more convenient retrieval process.

Request manager 130 generates metadata 260 and includes metadata 260 into response 250, which is sent to distribution tier component 100 over request path 115. Metadata 260 includes a temporary storage location identifier that corresponds to temporary store 240, and may also include a retrieval timeframe that distribution tier component 100 may retrieve the data. For example, enterprise tier component 120 may determine that the amount of time to transfer data 230 to temporary store 240 will take 10 minutes due to the size of data 230. In this example, metadata 260 includes a “time available” time that is 10 minutes after the transfer start, and may also include a “time expired” that corresponds to when the data query result will be removed from temporary store 240.

During the specified retrieval timeframe, distribution tier component 100 retrieves data 230 from temporary store 240 using data path 270, which does not congest request path 115. Data path 270 is configured for data access and retrieval and, therefore, does not use overhead application language such as that used in request path 115.

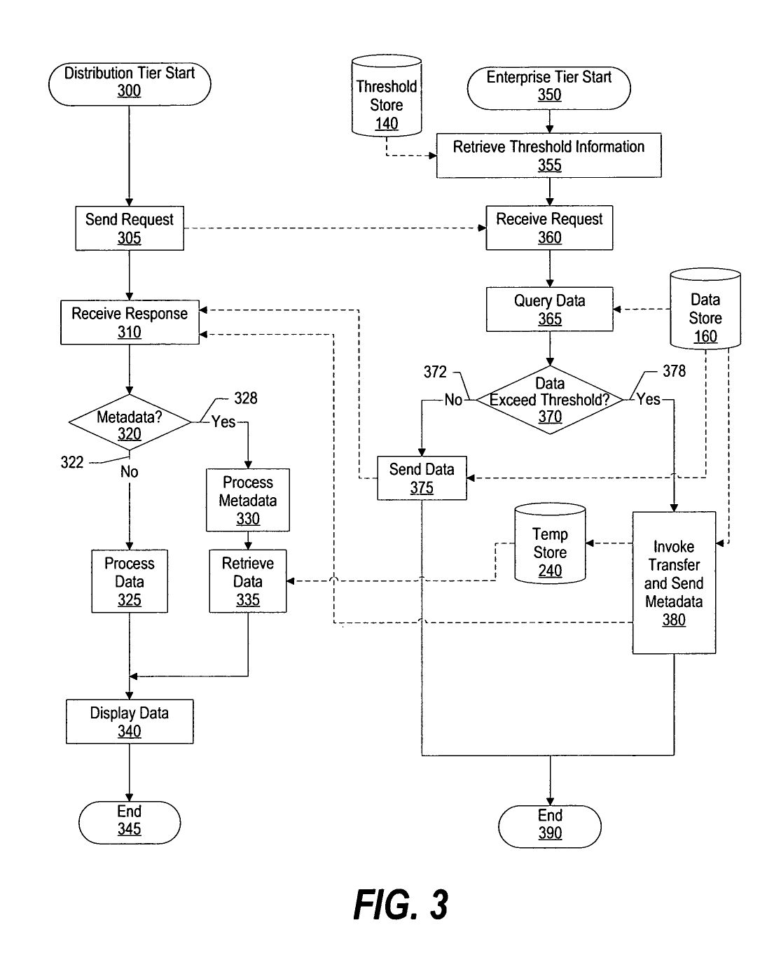

FIG. 3 is a flowchart showing steps taken in an enterprise tier component providing data to a distribution tier component through direct means or through a temporary storage area. The enterprise tier component and the distribution tier component are both server-side software components that work in conjunction with each other to provide information to a particular application. Enterprise tier component processing commences at 350, whereupon the enterprise tier component retrieves data thresholds from threshold store 140 at step 355. The enterprise tier component uses the data thresholds to determine whether to send data query result to the distribution tier component or, instead, send metadata to the distribution tier component in order for the distribution tier component to retrieve the data query result from a temporary storage area. The data thresholds may correspond to a maximum size of particular data or a maximum amount of time required to retrieve the data. Threshold store 140 is the same as that shown in FIG. 1, and may be stored on a nonvolatile storage area, such as a computer hard drive.

Distribution tier component processing commences at 300, whereupon the distribution tier component sends a query request to the enterprise tier component at step 305. The enterprise tier component receives the data query request at step 360, and queries the data located in data store 160 at step 365. For example, the data query may request customer transaction information for all customers that reside in a particular geographic region. Data store 160 is the same as that shown in FIG. 1.

A determination is made as to whether the data query result exceeds one of the retrieved data thresholds, such as over a maximum size (decision 370). Using the example described above, the customer transaction information for a particular region may exceed 50 MB. In one embodiment, the data threshold may be a security check threshold (security level of the data) or a data not ready threshold (data not ready in time to provide to the user). If the data does not exceed one of the data thresholds, decision 370 branches to “No” branch 372 whereupon the enterprise tier component sends the data query result to the distribution tier component (step 375), which the distribution tier component receives at step 310.

On the other hand, if the data query result exceeds one of the data thresholds, decision 370 branches to “Yes” branch 378 whereupon the enterprise tier component invokes a data transfer from data store 160 to temporary store 240, and sends metadata to the distribution tier component that includes a temporary storage identifier that identifies the location of the data query result (steps 380 and 310). The metadata may also include a timeframe that the distribution tier component is able to retrieve the data from temporary store 240. Temporary store 240 is the same as that shown in FIG. 2.

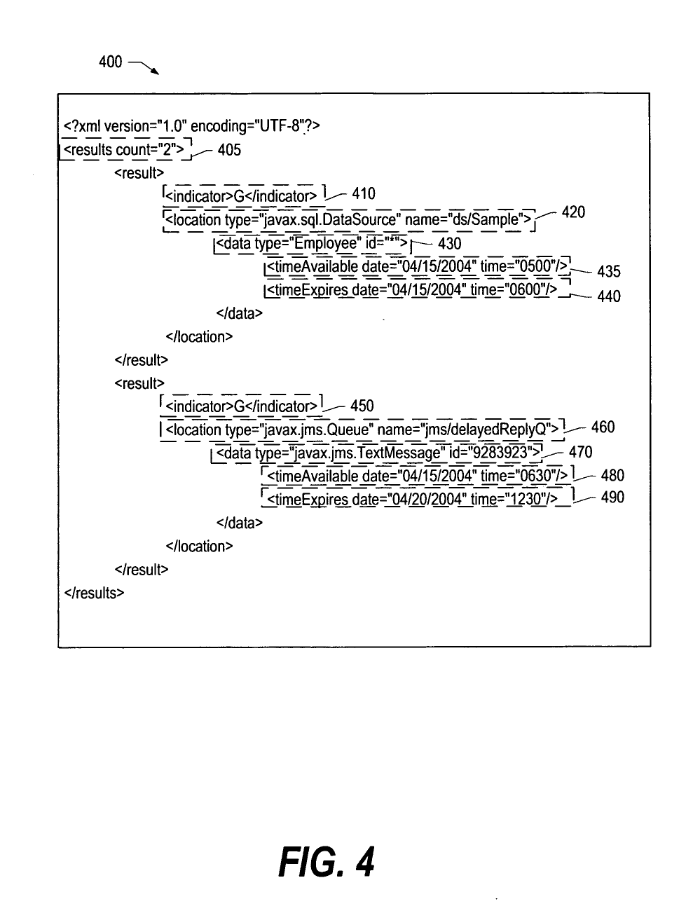

In one embodiment, the data query result may include multiple data types from multiple data locations. In this embodiment, the enterprise tier component includes metadata for each data type in the metadata that is sent to the distribution tier component (see FIG. 4 and corresponding text for further details). Enterprise tier component processing ends at 390.

When the distribution tier component receives a response from the enterprise tier component at step 310 (data query result or metadata), a determination is made as to whether the response includes the data query result or metadata (decision 320). If the response includes the data query result, decision 320 branches to “No” branch 322 whereupon processing processes the data query result at step 325. On the other hand, if the response includes metadata, decision 320 branches to “Yes” branch 328 whereupon processing processes the metadata at step 330. At step 335, the distribution tier component retrieves the data query result from temporary store 240. If the metadata includes a retrieval timeframe, the distribution tier component retrieves the data during the specified retrieved timeframe.

At step 340, processing displays the data for a user to view. Distribution tier component processing ends at 345.

FIG. 4 is an example of metadata that a server provides to a distribution tier component when the distribution tier component's data request exceeds one or more data thresholds. FIG. 4 shows an extensible Markup Language (XML) example that a server may send to a distribution tier component to inform the distribution tier component that it may retrieve data query results from particular locations.

Metadata 400 includes lines 405 through 490. Line 405 includes a number of results included in metadata 400, which is “2.” The first result is included in lines 410 through 440, and the second result is included in lines 450 through 490. Lines 410 and 450 include an indicator that informs the distribution tier component as to whether the distribution tier component's request results in an execution error “E,” the return data exceeds a particular data threshold “G,” or whether the return data does not exceed a particular data threshold “L,” in which case the data is returned to the distribution tier component (e.g., an SQL result set object). The example in FIG. 4 shows that lines 410 and 450 include a “G” indicator, which informs the distribution tier component that the return data for both results exceeds a particular threshold.

Lines 420 through 440 inform the distribution tier component that it may retrieve the first data portion by looking up the data source, “ds/Sample,” and querying the table, “Employee,” between 5 AM and 6 AM on Apr. 15, 2004. Lines 460 through 490 inform the distribution tier component that it may retrieve the second data portion by looking up the queue, “jms/delayedReplyQ” and the text message with id “9283923” between 6:30 AM on Apr. 15, 2004 and 12:30 PM on Apr. 20, 2004.

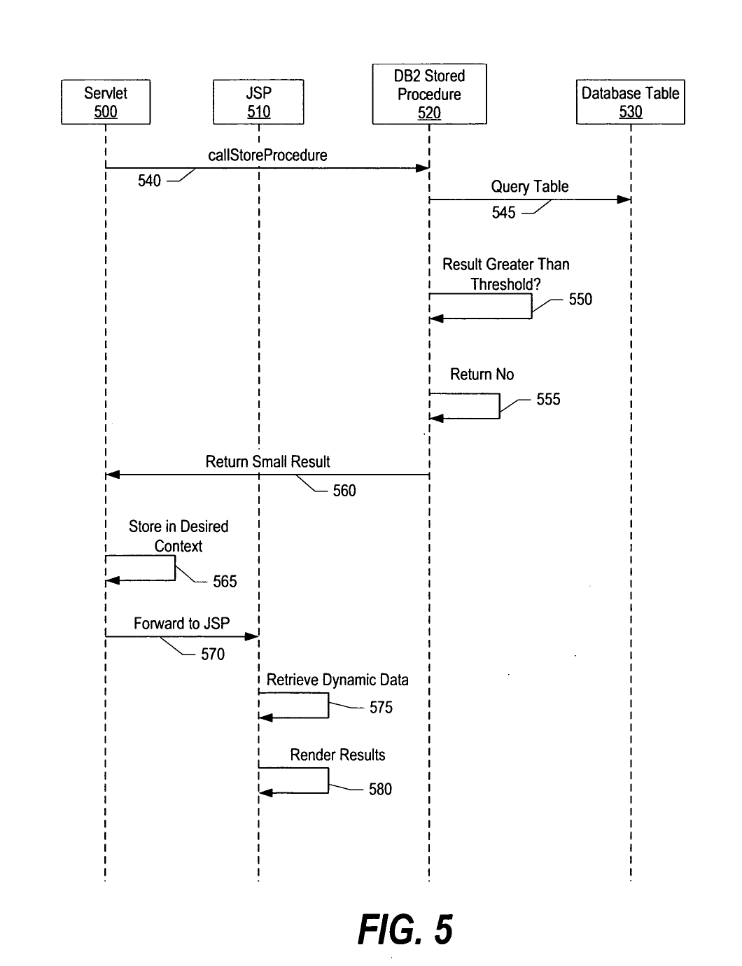

FIG. 5 is an interaction diagram corresponding to an embodiment of the present invention showing a stored procedure deciding that a data query result does not exceed one or more data thresholds. Servlet 600 sends call store procedure 540, which includes a data request, to DB2 stored procedure 520 over a request path. In turn, DB2 stored procedure 520 queries database table 530 via query table 545. DB2 stored procedure 520 determines (action 550) that the query result is not greater than one or more data thresholds (action 555). In turn, DB2 stored procedure 520 sends the data query result to servlet 500 over the request path (action 560).

Servlet 500 stores the result in the desired context (action 565) and forwards to Java Server Page (JSP) 510 via action 570. In turn, JSP 510 retrieves the data (action 575) and renders the result to the user (action 580).

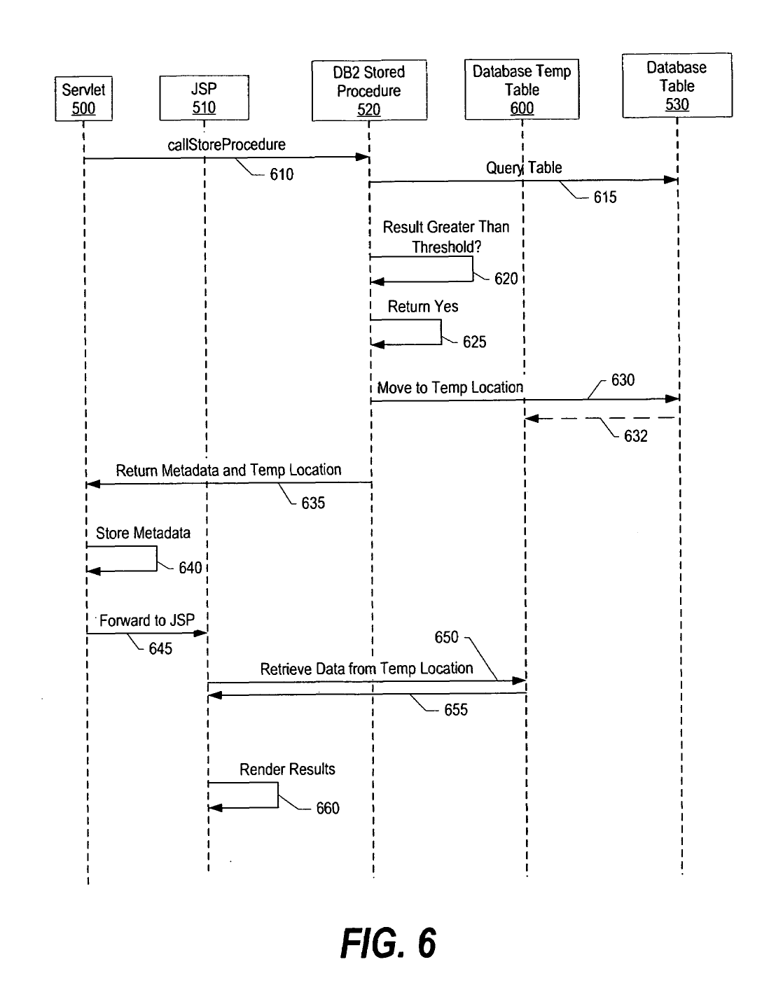

FIG. 6 is an interaction diagram corresponding to an embodiment of the present invention showing a stored procedure deciding that a data query result exceeds one or more data thresholds. Servlet 500 sends call store procedure 610, which includes a data request, to DB2 stored procedure 520 over a request path. In turn, DB2 stored procedure 520 queries database table 530 via query table 615. DB2 stored procedure 520 determines (action 620) that the query result is greater than one or more data thresholds (action 625). As a result, DB2 stored procedure 520 invokes an independent thread to move the data to a temporary storage area (actions 630 and 632). DB2 stored procedure 520 then sends metadata that includes the temporary storage area's location to servlet 500 over existing request flow means (action 635).

Servlet 500 stores the metadata (action 640) and forwards the metadata to Java Server Page (JSP) 510 via action 645. In turn, JSP 510 retrieves the data from database temporary table 600 (action 650 and 655) over a data path and renders the result to the user (action 660). Servlet 500, JSP 510, DB2 stored procedure 520, and database table 530 are the same as that shown in FIG. 5.

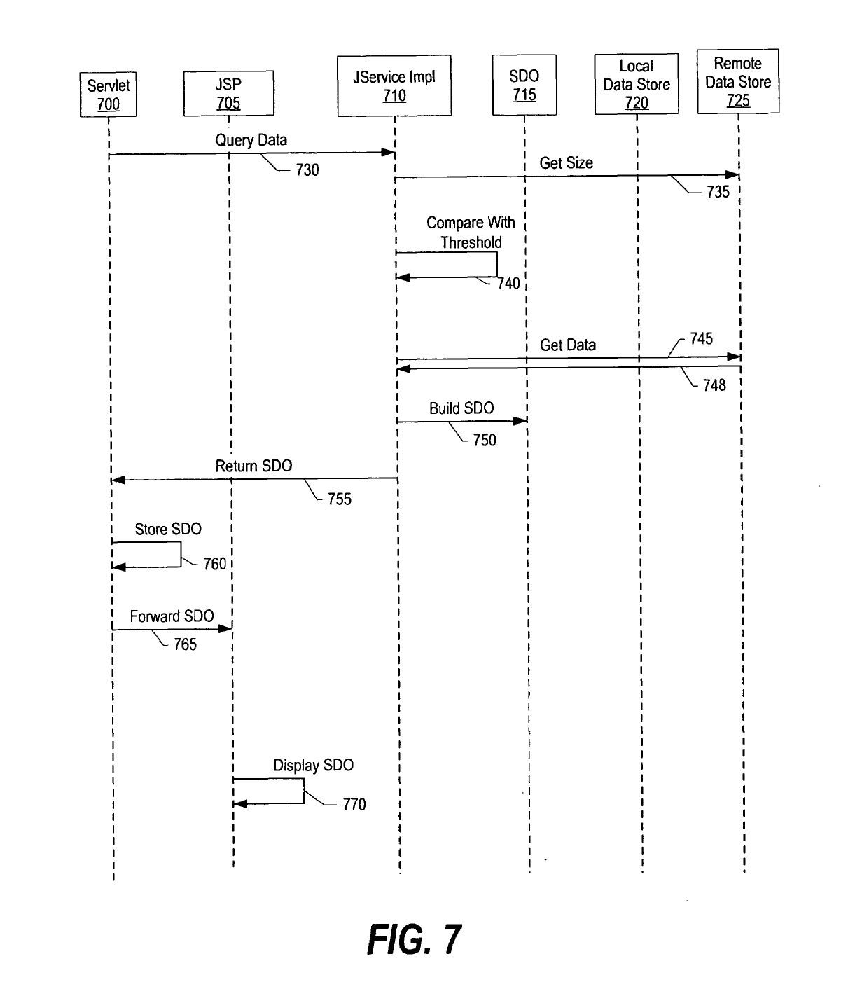

FIG. 7 is an interaction diagram corresponding to an embodiment of the present invention showing a middleware application deciding that a data query result does not exceed one or more data thresholds. Servlet 700 sends query data 730 to Jservice Implementation 710, which is a service-oriented J2EE application framework. Jservice implementation 710 defines services in XML, and calls them in a uniform way. In addition, Jservice implementation 710 is not bound to entity engines or other frameworks that, therefore, reduces code coupling between a client layer and a service layer, making distributed development possible.

Jservice Implementation 710 gets the size of the data (action 735) that is stored in remote data store 725, and determines (action 740) that the query result does not exceed a data threshold. As a result, Jservice Implementation 710 retrieves the data from remote data store 725 (actions 745 and 748).

Jservice Implementation 710 builds a service data object (SDO) (action 750), such as using a Java Bean Mediator, and passes the SDO to Servlet 700 (action 755). In turn, servlet 700 stores the SDO (action 760) and forwards the SDO to Java Server page (JSP) 705 (action 765), whereby JSP 705 displays the SDO to a user (action 770).

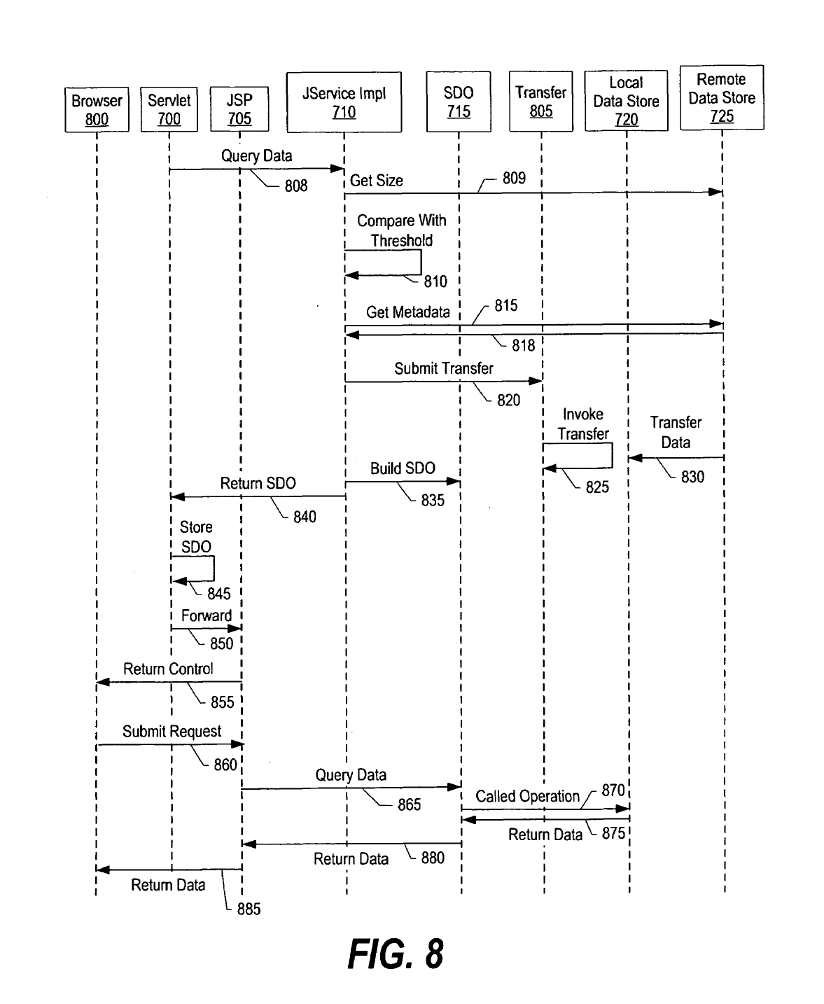

FIG. 8 is an interaction diagram corresponding to an embodiment of the present invention showing a middleware application deciding that a data query result exceeds one or more data thresholds. Servlet 700 sends query data 808 to Jservice Implementation 710. In turn, Jservice Implementation 710 gets the size of the data (action 809) that is stored in remote data store 725. Jservice Implementation 710 determines (action 810) that the query result exceeds a data threshold. As a result, Jservice Implementation 710 retrieves metadata corresponding to the data from remote data store 725, such as where to temporarily store the data (actions 815 and 818).

Jservice Implementation 710 invokes transfer 805 to transfer the data from remote data store 725 to local data store 720 via submit transfer 820, which is a separate, asynchronous, subroutine call. Transfer 805 invokes an independent thread (action 825) to transfer the data from remote data store 725 to local data store 720 via transfer data 830.

Jservice Implementation 710 also builds a service data object (SDO) (action 835) and passes the SDO to Servlet 700 (action 840). In turn, servlet 700 stores the SDO (action 845) and forwards the SDO to Java Server page (JSP) 705 (action 850). JSP 705 returns control to browser 800 (action 855). As a result, browser 800 submits a request (action 860) to JSP 705 to retrieve the data JSP 705 uses the generated SDO (SDO 715) to query the data located in local data store 720 (actions 865 and 870). In turn, the data is returned from local data store 720 to SDO 715 (action 875), which forwards the data to JSP 705 (action 880), which forwards the data to browser 800 (action 885), all through a data path.

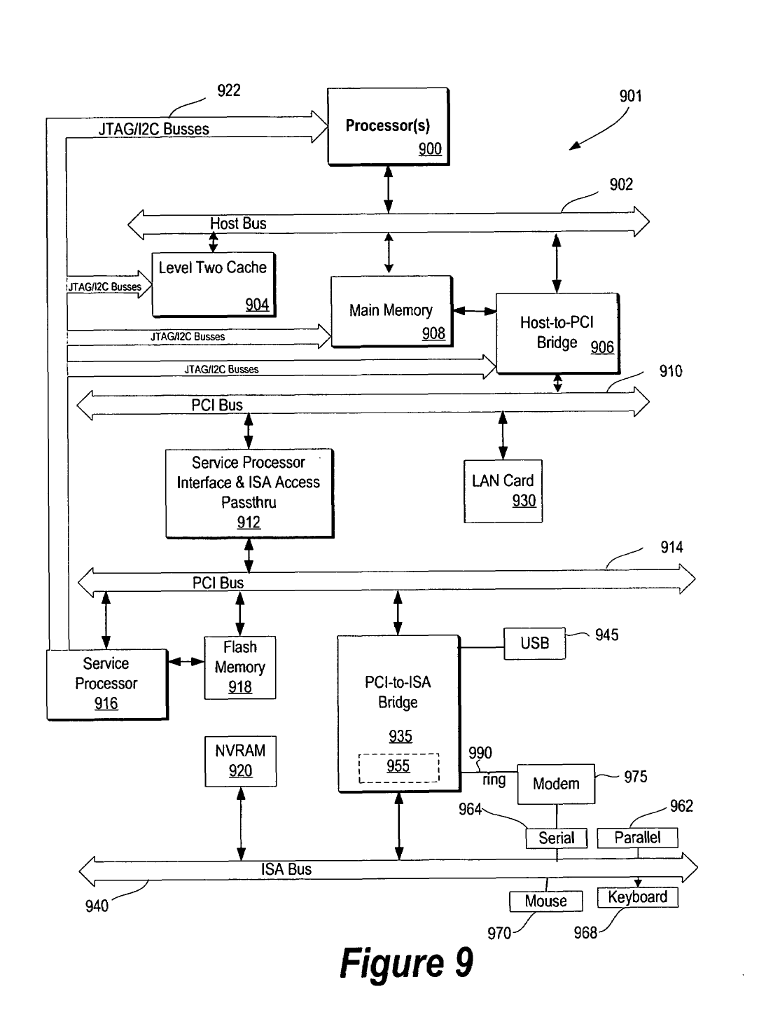

FIG. 9 illustrates information handling system 901 which is a simplified example of a computer system capable of performing the computing operations described herein. Computer system 901 includes processor 900 which is coupled to host bus 902. A level two (L2) cache memory 904 is also coupled to host bus 902. Host-to-PCI bridge 906 is coupled to main memory 908, includes cache memory and main memory control functions, and provides bus control to handle transfers among PCI bus 910, processor 900, L2 cache 904, main memory 908, and host bus 902. Main memory 908 is coupled to Host-to-PCI bridge 906 as well as host bus 902. Devices used solely by host processor(s) 900, such as LAN card 930, are coupled to PCI bus 910. Service Processor Interface and ISA Access Pass-through 912 provides an interface between PCI bus 910 and PCI bus 914. In this manner, PCI bus 914 is insulated from PCI bus 910. Devices, such as flash memory 918, are coupled to PCI bus 914. In one implementation, flash memory 918 includes BIOS code that incorporates the necessary processor executable code for a variety of low-level system functions and system boot functions.

PCI bus 914 provides an interface for a variety of devices that are shared by host processor(s) 900 and Service Processor 916 including, for example, flash memory 918. PCI-to-ISA bridge 935 provides bus control to handle transfers between PCI bus 914 and ISA bus 940, universal serial bus (USB) functionality 945, power management functionality 955, and can include other functional elements not shown, such as a real-time clock (RTC), DMA control, interrupt support, and system management bus support. Nonvolatile RAM 920 is attached to ISA Bus 940. Service Processor 916 includes JTAG and I2C busses 922 for communication with processor(s) 900 during initialization steps. JTAG/I2C busses 922 are also coupled to L2 cache 904, Host-to-PCI bridge 906, and main memory 908 providing a communications path between the processor, the Service Processor, the L2 cache, the Host-to-PCI bridge, and the main memory. Service Processor 916 also has access to system power resources for powering down information handling device 901.

Peripheral devices and input/output (I/O) devices can be attached to various interfaces (e.g., parallel interface 962, serial interface 964, keyboard interface 968, and mouse interface 970 coupled to ISA bus 940. Alternatively, many I/O devices can be accommodated by a super I/O controller (not shown) attached to ISA bus 940.

In order to attach computer system 901 to another computer system to copy files over a network, LAN card 930 is coupled to PCI bus 910. Similarly, to connect computer system 901 to an ISP to connect to the Internet using a telephone line connection, modem 975 is connected to serial port 964 and PCI-to-ISA Bridge 935.

While FIG. 9 shows one information handling system that employs processor(s) 900, the information handling system may take many forms. For example, information handling system 901 may take the form of a desktop, server, portable, laptop, notebook, or other form factor computer or data processing system. Information handling system 901 may also take other form factors such as a personal digital assistant (PDA), a gaming device, ATM machine, a portable telephone device, a communication device or other devices that include a processor and memory.

One of the preferred implementations of the invention is a distribution tier component application, namely, a set of instructions (program code) in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method comprising:
receiving, at a first software component, a data query request from a second software component over a request path;
retrieving, at the first software component, a data query result corresponding to the data query request;
comparing the data query result with a data threshold;
in response to the data query result not exceeding the data threshold, providing the data query result from the first software component to the second software component over the request path; and
in response to the data query result exceeding the data threshold, storing the data query result in a temporary storage area and providing metadata from the first software component to the second software component over the request path, the metadata including a temporary storage identifier corresponding to the temporary storage area.

2. The method of claim 1 wherein the data threshold is selected from the group consisting of a size limit threshold, a time limit threshold, a data not ready threshold, and a security check threshold.

3. The method of claim 1 further comprising:
extracting, at the second software component, the temporary storage identifier from the metadata; and
retrieving, at the second software component, the data query result from the temporary storage area based upon the temporary storage identifier, the data query result retrieval performed over a data path which is different than the request path.

4. The method of claim 3 further comprising:
extracting, at the second software component, a retrieval timeframe from the metadata that indicates a timeframe that the data query result is available at the temporary storage area; and
performing the retrieving during the retrieval timeframe.

5. The method of claim 3 wherein the request path includes an extensible mark-up language and the data path does not include the extensible mark-up language.

6. The method of claim 1 wherein the metadata includes a plurality of temporary storage identifiers, each temporary storage identifier corresponding to different data query results that are retrieved from a plurality of data storage areas.

7. The method of claim 1 further comprising:
wherein the temporary storage area is co-located with the second software component; and
wherein the first software component and the second software component are at different locations.

8. A computer program product stored on a computer operable media, the computer operable media containing instructions for execution by a computer, which, when executed by the computer, cause the computer to implement a method for providing data, the method comprising:
receiving, at a first software component, a data query request from a second software component over a request path;
retrieving, at the first software component, a data query result corresponding to the data query request;
comparing the data query result with a data threshold;
in response to the data query result not exceeding the data threshold, providing the data query result from the first software component to the second software component over the request path; and
in response to the data query result exceeding the data threshold, storing the data query result in a temporary storage area and providing metadata from the first software component to the second software component over the request path, the metadata including a temporary storage identifier corresponding to the temporary storage area.

9. The computer program product of claim 8 wherein the data threshold is selected from the group consisting of a size limit threshold, a time limit threshold, a data not ready threshold, and a security check threshold.

10. The computer program product of claim 8 wherein the method further comprises:
extracting, at the second software component, the temporary storage identifier from the metadata; and
retrieving, at the second software component, the data query result from the temporary storage area based upon the temporary storage identifier, the data query result retrieval performed over a data path which is different than the request path.

11. The computer program product of claim 10 wherein the method further comprises:
extracting, at the second software component, a retrieval timeframe from the metadata that indicates a timeframe that the data query result is available at the temporary storage area; and
performing the retrieving during the retrieval timeframe.

12. The computer program product of claim 10 wherein the request path includes an extensible mark-up language and the data path does not include the extensible mark-up language.

13. The computer program product of claim 8 wherein the metadata includes a plurality of temporary storage identifiers, each temporary storage identifier corresponding to different data query results that are retrieved from a plurality of data storage areas.

14. The computer program product of claim 8 wherein the method further comprises:
wherein the temporary storage area is co-located with the second software component; and
wherein the first software component and the second software component are at different locations.

15. An information handling system comprising:
one or more processors;
a memory accessible by the processors;
one or more nonvolatile storage devices accessible by the processors; and
a data distribution tool for providing data, the data distribution tool being effective to:
receive, at a first software component, a data query request from a second software component over a request path;
retrieve, at the first software component, a data query result from one of the nonvolatile storage devices corresponding to the data query request;
compare the data query result with a data threshold;
in response to the data query result not exceeding the data threshold, provide the data query result from the first software component to the second software component over the request path; and
in response to the data query result exceeding the data threshold, store the data query result in a temporary storage area located in one of the nonvolatile storage devices and provide metadata from the first software component to the second software component over the request path, the metadata including a temporary storage identifier corresponding to the temporary storage area.

16. The information handling system of claim 15 wherein the data threshold is selected from the group consisting of a size limit threshold, a time limit threshold, a data not ready threshold, and a security check threshold.

17. The information handling system of claim 15 further wherein the data distribution tool is further effective to:
extract, at the second software component, the temporary storage identifier from the metadata; and
retrieve, at the second software component, the data query result from the temporary storage area based upon the temporary storage identifier, the data query result retrieval performed over a data path which is different than the request path.

18. The information handling system of claim 17 wherein the data distribution tool is further effective to:
extract, at the second software component, a retrieval timeframe from the metadata that indicates a timeframe that the data query result is available at the temporary storage area; and
perform the retrieving during the retrieval timeframe.

19. The information handling system of claim 17 wherein the request path includes an extensible mark-up language and the data path does not include the extensible mark-up language.

20. The information handling system of claim 15 wherein the metadata includes a plurality of temporary storage identifiers, each temporary storage identifier corresponding to different data query results that are retrieved from a plurality of data storage areas that are located in one or more of the nonvolatile storage devices.
